(19) United States
(12) Patent Application Publication
(10) Pub. No.: US 2015/0155541 A1
(43) Pub. Date: Jun. 4, 2015

(54) SEPARATOR PRODUCTION METHOD AND NON-AQUEOUS ELECTROLYTE SECONDARY BATTERY

(71) Applicant: SUMITOMO CHEMICAL COMPANY, LIMITED, Tokyo (JP)

(72) Inventor: Hirohiko Hasegawa, Niihama-shi (JP)

(73) Assignee: SUMITOMO CHEMICAL COMPANY, LIMITED, Tokyo (JP)

(21) Appl. No.: 14/406,784

(22) PCT Filed: Jun. 17, 2013
(86) PCT No.: PCT/JP2013/067154

§ 371 Date: Dec. 10, 2014

(30) Foreign Application Priority Data
Jun. 20, 2012 (JP) 2012-138355

(51) Int. Cl. H01M 2/16; H01M 2/14

(52) U.S. Cl. CPC H01M 2/1686; H01M 2/145; H01M 2/1653

(57) ABSTRACT

A production method according to the present invention is a method comprising impregnating a laminated porous film, which is formed by laminating a heat-resistant layer containing polyvinyl alcohol (PVA) and an inorganic filler on one side or both sides of a substrate material porous film predominantly composed of polyolefin, with a solution containing a compound having the ability of cross-linking PVA, and then removing a solvent. The present invention can produce a separator having excellent heat shape retainability even when PVA is used for a binder resin for forming a heat-resistant layer.

### TECHNICAL FIELD

The present invention relates to a method for producing a separator and a non-aqueous electrolyte secondary battery including the separator.

### BACKGROUND ART

A non-aqueous electrolyte secondary battery typified by these lithium secondary batteries has a high energy density, and high electric current flows in the battery to excessively generate heat when an internal short circuit or an external short circuit occurs due to the failure of the battery or due to the failure of equipment using the battery. Thus, it has been required to prevent heat generation equal to or above a certain level and ensure high safety in the non-aqueous electrolyte secondary battery.

As means for ensuring the safety, a method of imparting a shutdown function, which blocks ion passage between positive electrode and negative electrode through a separator to prevent further heat generation at the time of abnormal heat generation, is common. An example of the method of imparting a shutdown function to a separator includes a method of using a porous film made of a material which melts at the time of abnormal heat generation as a separator. That is, in a battery using the separator, the porous film melts and becomes nonporous at the time of abnormal heat generation, and therefore ion passage can be blocked to suppress further heat generation.

As the separator having such a shutdown function, for example, a porous film made of polyolefin is used. A separator comprising the porous film made of polyolefin melts or becomes nonporous at about 80 to 180° C. at the time of abnormal heat generation of a battery, and thereby, ion passage can be blocked (shut down) to suppress further heat generation. However, for example, when the heat generation is excessive, the separator comprising the porous film may cause a short circuit due to direct contact between positive electrode and negative electrode by shrinkage or breakage of the film. Thus, the separator comprising the porous film made of polyolefin has insufficient shape stability and may not suppress abnormal heat generation due to short circuit.

As means for ensuring safety in abnormal heat generation of a battery, there is proposed a separator for a non-aqueous electrolyte secondary battery comprising a laminated porous film which is formed by laminating an inorganic filler heat-resistant layer using carboxymethyl cellulose (hereinafter, may be referred to as “CMC”) or polyvinyl alcohol (hereinafter, may be referred to as “PVA”) as a binder and a porous film (hereinafter, may be referred to as a “substrate material porous film”) predominantly composed of polyolefin as a substrate material (e.g., see Patent Documents 1 and 2). However, the laminated porous film in which CMC is used as a binder resin has excellent heat shape stability, but has a problem of suppressing exfoliation of the filler from the surface of the laminated porous film, a so-called “powder fall-off”.

On the other hand, when the laminated porous film where PVA is used as a binder resin is used as a separator, there is a problem that a short circuit between both electrodes tends to occur due to shrinkage of the separator in the continuing rise of temperature over the shutdown temperature.

### PRIOR ART DOCUMENT

### Patent Documents

Patent Document 1: JP-A-2004-227972

Patent Document 2: JP-A-2008-186721

### DISCLOSURE OF THE INVENTION

It is an object of the present invention to provide a method for producing a separator having excellent heat shape retainability even when PVA is used for a binder resin for forming a heat-resistant layer, and a non-aqueous electrolyte secondary battery using a separator obtained by the method.

In order to solve the above problems, the present inventor has made earnest investigations, and consequently has completed the present invention.

That is, the present invention includes the following aspects.

<1> A method for producing a separator, the method comprising impregnating a laminated porous film, which is formed by laminating a heat-resistant layer containing polyvinyl alcohol (PVA) and an inorganic filler on one side or both sides of a substrate material porous film predominantly composed of polyolefin, with a solution containing a compound having the ability of cross-linking PVA, and then removing a solvent.

<2> The method for producing a separator according to <1>, wherein the compound having the ability of cross-linking PVA is boric acid and/or an organometallic compound having the ability of cross-linking PVA.

<3> The method for producing a separator according <2>, wherein the organometallic compound having the ability of cross-linking PVA is an organic titanium compound having the ability of cross-linking PVA.

<4> The method for producing a separator according <3>, wherein the organic titanium compound is titanium lactate.

<5> The method for producing a separator according to any one of <1> to <4>, wherein the solvent in the solution containing a compound having the ability of cross-linking PVA is a solvent predominantly composed of water.

<6> The method for producing a separator according to any one of <1> to <5>, wherein the inorganic filler is alumina.

<7> The method for producing a separator according to any one of <1> to <6>, wherein a proportion of polyvinyl alcohol in the heat-resistant layer is 1 part by weight or more and 5 parts by weight or less with respect to 100 parts by weight of the inorganic filler.

<8> A non-aqueous electrolyte secondary battery including a separator obtained by the method according to any one of <1> to <7>.

The production method of the present invention provides a separator which has heat shape retainability and is suitable for a separator for a non-aqueous electrolyte secondary battery. The separator for a non-aqueous electrolyte secondary battery obtained by the production method of the present invention is excellent in uniformity of film thickness.

Hereinafter, the present invention will be described in detail byway of exemplifications, but the present invention is not limited to the following exemplifications and arbitrary variations may be made without departing from the gist of the invention.

### <Laminated Porous Film>

In the method for producing a separator of the present invention, the laminated porous film to be a subject is a laminated porous film formed by laminating a heat-resistant layer (hereinafter, may be referred to as a “B layer”) containing polyvinyl alcohol (PVA) as a binder resin and an inorganic filler on a substrate material porous film (hereinafter, may be referred to as a “A layer”).

Hereinafter, the A layer and the B layer respectively constituting the laminated porous film will be described in detail.

### <Substrate Material Porous Film (A Layer)>

The substrate material porous film (A layer) is a porous film predominantly composed of polyolefin (porous polyolefin film), has a structure having continuous fine pores therein, and is configured such that vapor or liquid can permeate the layer from one surface to the other surface.

Since the A layer has the property of melting at high temperatures to be nonporous, when a laminated porous film formed by laminating the B layer on the A layer is used as a separator, a shutdown function is imparted to the laminated porous film by melting the A layer to be nonporous at the time of abnormal heat generation. The percentage of the polyolefin component is essentially 50% by volume or more of the whole A layer, preferably 90% by volume or more, and more preferably 95% by volume or more.

Further, the polyolefin component of the A layer preferably contains a high molecular weight component having a weight average molecular weight of 5×10⁵ to 150×10⁵. In the porous polyolefin film constituting the A layer, if the A layer contains a polyolefin component having a weight average molecular weight of 1000000 or more as a polyolefin component, it is preferred since the strength of the A layer is improved, and further the strength of the whole laminated porous film including the A layer is enhanced.

Examples of the polyolefin include high molecular weight homopolymers and copolymers obtained by polymerizing ethylene, propylene, 1-butene, 4-methyl-1-pentene, 1-hexene, etc. Among these, a high molecular weight polyethylene, which is predominantly composed of ethylene and has a weight average molecular weight of 1000000 or more, is preferred.

The pore size of the A layer is preferably 3 μm or less, and more preferably 1 μm or less from the viewpoint of the ion permeability and the prevention of particle penetration into positive electrode or negative electrode when the A layer is used as a separator of a battery.

The A layer has an air permeability (as Gurley value) of usually 30 to 1000 seconds/100 cc, and preferably 50 to 500 seconds/100 cc.

When the A layer has the air permeability in the above range, sufficient ion permeability can be attained when the A layer is used as a separator.

The thickness of the A layer is appropriately determined in consideration of the thickness of the heat-resistant layer (B layer) of the laminated porous film, and it is preferably 4 to 40 μm, and more preferably 7 to 30 μm.

The A layer has a porosity of preferably 20 to 80% by volume, and more preferably 30 to 70% by volume. When the porosity is within such a range, the A layer has excellent ion permeability and exhibits excellent characteristics when used as a separator for a non-aqueous electrolyte secondary battery. When the porosity is less than 20% by volume, the amount of the electrolyte to be retained may be small, and when the porosity is more than 80% by volume, it may be insufficient to make the A layer nonporous at temperatures at which shutdown occurs, that is, there is a possibility that an electric current cannot be blocked at abnormal heat generation.

The A layer has a weight per unit area of usually 4 to 15 g/m², and preferably 5 to 12 g/m² in that the strength, thickness, handleability and weight of the laminated porous film can be improved and further in that the weight energy density or volume energy density of a battery can be increased when the A layer is used as a separator of the battery.

A production method for the A layer is not particularly limited, and examples thereof include a method in which a plasticizer is added to a thermoplastic resin and the resulting resin is formed into a film, and then the plasticizer is removed by using an appropriate solvent, as shown in JP-A-H07-29563, and a method in which using a film made of a thermoplastic resin produced by a known method, a structurally weak amorphous portion of the film composed of a thermoplastic resin is selectively stretched to form a fine pore, as shown in JP-A-H07-304110. For example, when the A layer is formed from ultra-high molecular weight polyethylene and a polyolefin resin containing a low-molecular weight polyolefin having a weight average molecular weight of 10000 or less, a method of performing the following steps (1) to (4) is suitable from the viewpoint of production cost.

That is, (1) a step of kneading 100 parts by weight of ultra-high molecular weight polyethylene, 5 to 200 parts by weight of a low-molecular weight polyolefin having a weight average molecular weight of 10000 or less and 100 to 400 parts by weight of an inorganic filler such as calcium carbonate to prepare a polyolefin resin composition;

(2) a step of forming the polyolefin resin composition into a sheet;
(3) a step of removing the inorganic filler from the sheet formed in the step (2); and
(4) a step of stretching the sheet formed in the step (3) to obtain an A layer.

For the A layer, a commercialized product having the above-mentioned characteristics can be used.

### <Heat-Resistant Layer (B Layer)>

In the B layer, as the inorganic filler, an inorganic filler commonly referred to as a filler can be used. Specific examples of the inorganic filler include fillers made of inorganic materials such as calcium carbonate, talc, clay, kaolin, silica, hydrotalcite, diatom earth, magnesium carbonate, barium carbonate, calcium sulfate, magnesium sulfate, barium sulfate, aluminum hydroxide, magnesium hydroxide, calcium oxide, magnesium oxide, titanium oxide, alumina, mica, zeolite and glass. These fillers can be used singly, or can be used as a mixture of two or more thereof.

Among these, inorganic oxides are preferred as the inorganic filler, and alumina is more preferred from the viewpoint of heat resistance and chemical stability.

Many crystal forms such as α-alumina, β-alumina, γ-alumina, and θ-alumina exist in alumina, and any crystal form can be suitably used. Among these, α-alumina is preferred in point of high thermal stability and chemical stability.

The inorganic filler can take various forms such as a spherical shape, an oval shape, a rectangular shape or an indefinite shape not having a specific shape according to a production method for an inorganic filler material or a dispersing condition in preparing a coating liquid, and any thereof can be used.

The content of the inorganic filler is preferably 60% by volume or more, and more preferably 70% by volume or more when the whole solid content in the B layer is taken as 100% by volume so that the voids formed by contact between the inorganic fillers are less closed with another constituent material such as a binder resin and the ion permeability is maintained high in forming the heat-resistant layer.

In the B layer, PVA has a function as a binder resin of the inorganic filler. PVA having a higher degree of saponification is preferred in that at least in the heat generation of a battery, PVA in the B layer is cross-linked by a PVA cross-linking compound added in a post-process described later, and the PVA in the B layer has many points of cross-linking with a compound having the ability of cross-linking PVA.

On the other hand, partially unsaponified PVA is less likely to cause foaming than fully saponified PVA in stirring for the preparation of the coating liquid, and therefore the degree of saponification is preferably 75 to 95%, and more preferably 80 to 90%. The degree of polymerization of PVA is preferably 200 or more from the viewpoint of good ability to be bound to the inorganic filler, and preferably 5000 or less from the viewpoint of good dissolution in water.

Further, the heat-resistant layer may contain a small amount of another binder resin other than PVA as required to such an extent that the object of the present invention is not impaired.

The amount of the PVA (total amount of PVA and another binder resin when the heat-resistant layer contains another binder resin), although depending on the kind or particle size of the filler, is preferably 1 to 5 parts by weight with respect to 100 parts by weight of the filler. When the amount is more than 5 parts by weight, there is a possibility that the ion permeability of the B layer may be insufficient, and when the amount is less than 1 part by weight, the amount of powder fall-off of the B layer tends to increase.

The thickness of the B layer is usually 0.1 μm or more and 10 μm or less, and preferably in the range of 2 μm or more and 6 μm or less. When the thickness of the B layer is too large, there is a possibility that the load characteristics of a non-aqueous electrolyte secondary battery may be deteriorated in the case of producing the battery, and on the other hand, when the thickness is too small, there is a possibility that the separator may shrink without standing the thermal shrinkage of the polyolefin porous membrane in the occurrence of the abnormal heat generation of the battery.

When the B layer is formed on both sides of the A layer, the thickness of the B layer refers to a total thickness of both sides.

The B layer is formed as a porous membrane, and the pore size thereof is preferably 3 μm or less, and more preferably 1 μm or less in terms of the diameter of a circle which is closely analogous to the pore. When the average pore size is more than 3 μm, there is a possibility to cause a problem such that a short circuit tends to occur when a carbon powder which is a main component of positive electrode or negative electrode or small pieces thereof are exfoliated.

The B layer has a porosity of preferably 30 to 90% by volume, and more preferably 40 to 85% by volume.

### <Method for Producing Laminated Porous Film>

The method for producing a laminated porous film is not particularly limited as long as it is a method capable of obtaining a porous film in which the A layer and the B layer are laminated, and a method comprising preparing a coating liquid containing an inorganic filler and polyvinyl alcohol, applying the coating liquid directly onto a substrate material porous film, and removing a solvent (dispersing medium) is simple and preferred.

As the solvent (dispersing medium) of the coating liquid, a solvent predominantly composed of water which has the property that PVA is dissolved in water and the property that the inorganic filler is dispersed in water is preferred. The phrase “solvent predominantly composed of water” as used herein means a solvent containing water in an amount of 50% by volume or more.

The solvent predominantly composed of water is preferably a mixed solvent of water and an organic polar solvent in that the rate of drying and removing the solvent can be accelerated.

As the organic polar solvent to be used for the mixed solvent, alcohols which are compatible with water at an arbitrary ratio and have moderate polarity are suitable, and among the alcohols, methanol, ethanol and isopropyl alcohol are preferred. A ratio between water and the polar solvent is selected in consideration of leveling property and kind of a binder resin to be used to such an extent that a contact angle range above is achieved, and the mixed solvent usually contains water in an amount of 50% by weight or more, and preferably 70% by weight or more.

Further, the coating liquid may contain components other than the inorganic filler and the binder resin as required within a range which does not impair the object of the present invention. Examples of such a component include a dispersant, a thickener, a plasticizer, and a pH adjuster.

A method of dispersing the above-mentioned inorganic filler to prepare a coating liquid is not particularly limited as long as it is a method required for obtaining a homogenous coating liquid. Examples thereof include a mechanical stirring method, an ultrasonic dispersion method, a high-pressure dispersion method, and a media dispersion method, and among these, a high-pressure dispersion method is preferred in that the inorganic filler can be highly dispersed, and the inorganic filler can be blended into the dispersant in a short time.

A mixing order is not limited as long as there is no particular problem such as the occurrence of precipitate.

A method of applying the coating liquid onto one side or both sides of the substrate material porous film is not particularly limited as long as it is a method capable of performing wet-coating uniformly, and a conventionally known method can be employed.

For example, a capillary coating method, a spin coating method, a slit die coating method, a spray coating method, a dip coating method, a roll coating method, a screen printing method, a flexographic printing method, a bar coater method, a gravure coater method, and a die coater method can be employed. The thickness of the B layer to be formed can be controlled by adjusting the amount to be applied and the concentration of solid content in the coating liquid.

Although the coating liquid can be directly applied onto the substrate material porous film, it is preferred that the substrate material porous film is previously subjected to a hydrophilization treatment. By subjecting the substrate material porous film to a hydrophilization treatment, the coatability of the substrate material porous film is improved, and a more homogenous heat-resistant layer (B layer) can be achieved. The hydrophilization treatment is effective particularly when the concentration of water in the solvent is high.

Specific examples of the hydrophilization treatment method of the substrate material porous film include a chemical treatment of the substrate material porous film by acid or alkali, a corona discharge treatment, and a plasma treatment.

In a corona discharge treatment, there are advantages that the substrate material porous film can be hydrophilized in a relatively short time, and the hydrophilization treatment of a polyolefin resin by corona discharge is limited to an area in the vicinity of the surface of a membrane, and therefore high coatability can be ensured without changing the property of the interior of the substrate material porous film.

As the method of removing a medium (dispersion medium) from the coating liquid applied onto the substrate material porous film, a method by drying is generally used.

When the coating liquid is applied onto one side or both sides of the substrate material porous film, the drying temperature of the medium is a temperature at which the air permeability of the substrate material porous film is not deteriorated, that is, a temperature equal to or lower than the temperature at which shutdown occurs.

In the case of laminating the B layer on both sides of the substrate material porous film (A layer), a sequentially laminating method in which the B layer is formed on one side and then laminating the B layer on the other side, or a simultaneously laminating method in which the B layer is formed simultaneously on both sides of the substrate material porous film (A layer) is employed.

In the production method of the present invention, the thickness of the whole laminated porous film (A layer+B layer) is usually 5 to 80 μm, preferably 5 to 50 μm, and particularly preferably 6 to 35 μm. When the thickness of the whole laminated porous film is less than 5 μm, the film is apt to break. When the thickness is too large, the electric capacitance of a battery tends to decrease when the laminated porous film is used as a separator for a non-aqueous secondary battery.

The whole laminated porous film has a porosity of usually 30 to 85% by volume, and preferably 35 to 80% by volume.

The laminated porous film has an air permeability (as Gurley value) of preferably 50 to 2000 seconds/100 cc, and more preferably 50 to 1000 seconds/100 cc.

A battery having a smaller value of air permeability in such a range can exert high load characteristics since the laminated porous film exhibits more sufficient ion permeability and cycle characteristics when a non-aqueous electrolyte secondary battery is produced by using the laminated porous film as the separator of the present invention.

The laminated porous film may include a porous membrane such as an adhesion film or a protective film other than the substrate material porous film (A layer) and the heat-resistant layer (B layer) within a range which does not impair the object of the present invention.

### <Method for Producing Separator>

The separator according to the present invention can be produced by impregnating at least the B layer of the laminated porous film with a solution containing a compound having the ability of cross-linking PVA (PVA cross-linking compound) (hereinafter, may be referred to as a “cross-linking solution”), and then removing a solvent.

In the production method of the present invention, the PVA cross-linking compound contained in the cross-linking solution, with which the B layer is impregnated, has an action of cross-linking PVA serving as a binder resin of the B layer. In the separator according to the present invention, the PVA cross-linking compound may be added to at least the B layer. It is preferred that the crosslinking reaction of PVA by the PVA cross-linking compound proceeds at the stage of impregnating the B layer with the cross-linking solution and removing a solvent of the cross-linking solution because the deformation of the separator due to heat is small and handleability in preparing a battery is improved. On the other hand, in terms of the safety of a battery, the crosslinking reaction does not always need to proceed at the stage of removing the solvent, and even if the crosslinking reaction has not proceeded significantly at this stage, the crosslinking reaction may proceed by the heat in the heat generation of a battery

The PVA cross-linking compound may be a compound having an action of cross-linking PVA, and examples thereof include boric acid and/or an organometallic compound having the ability of cross-linking PVA.

Examples of the organometallic compound having the ability of cross-linking PVA include titanium organic compounds, zirconium organic compounds, aluminum organic compounds, and silicon organic compounds. These organometallic compounds may be used singly, or may be used as a mixture of appropriately selected two or more thereof.

Examples of the titanium organic compound include titanium orthoesters such as tetra-n-butyl titanate, tetraisopropyl titanate, butyl titanate dimer, tetra(2-ethylhexyl)titanate and tetramethyl titanate; titanium chelates such as titanium acetylacetonate, titanium tetraacetylacetonate, polytitanium acetylacetonate, titanium octyleneglycolate, titanium lactate, titanium triethanolaminate and titanium ethylacetoacetate; titanium acylates such as polyhydroxy titanium stearate; and the like.

Examples of the zirconium organic compound include zirconium-n-propylate, zirconium-n-butyrate, zirconium tetraacetylacetonate, zirconium monoacetylacetonate, zirconium bisacetylacetonate, and zirconium acetylacetonate bisethylacetoacetonate, and the like.

Examples of the aluminum organic compound include aluminum acetylacetonate, aluminum organic acid chelate and the like.

Examples of the silicon organic compound include compounds having a ligand exemplified in the titanium organic compounds and the zirconium organic compounds.

The PVA cross-linking compounds may be used singly, or may be used as a mixture of appropriately selected two or more thereof.

The solvent of the cross-linking solution is not particularly limited as long as it is a solvent in which the PVA cross-linking compound is uniformly dissolved or dispersed; however, a solvent predominantly composed of water is preferred in terms of environmental burden and a process and further because of an efficient progression of the crosslinking reaction since the applied cross-linking solution exists selectively in the B layer. As a solvent other than water, a solvent, which is similar to the coating liquid for producing the B layer described above, can be used.

The method of impregnating the B layer with the cross-linking solution is not particularly limited as long as it is a method capable of uniformly infiltrating the cross-linking solution into the B layer, and examples of the method include a method in which the laminated porous film is immersed in the cross-linking solution, and then an excessive cross-linking solution is removed by flow-down, and a method of infiltrating the cross-linking solution into the B layer by coating the surface of the laminated porous film with the cross-linking solution. As the latter coating method, a conventionally known method can be employed. For example, a capillary coating method, a spin coating method, a slit die coating method, a spray coating method, a roll coating method, a screen printing method, a flexographic printing method, a bar coater method, a gravure coater method, and a die coater method can be employed.

The concentration of the PVA cross-linking compound in the cross-linking solution may be such that the B layer can be impregnated with the PVA cross-linking compound by the above method in an amount required for adequately cross-linking the PVA in the B layer, and the concentration, although depending on the method of impregnation, is preferably 0.5 to 5% by weight, and more preferably 1 to 4% by weight. The concentration of 0.5% by weight or more is preferred because of low load in the process for removing a solvent, and the concentration of 5% by weight or less is preferred because of the pores of the laminated porous film being hardly closed.

The removal of the solvent after impregnating the B layer with the cross-linking solution is preferably carried out by heating and drying. The drying temperature of the solvent needs to be a temperature at which the air permeability of the substrate material porous film is not deteriorated, that is, a temperature equal to or lower than the temperature at which shutdown occurs, and the drying temperature is preferably 40° C. or higher since the crosslinking reaction tends to proceed. It is preferred that heating at 40° C. or higher is continued for several seconds to several minutes after removing the solvent in order to accelerate the crosslinking reaction. With respect to the heating step after removing the solvent, it is convenient and preferred that a drying furnace is lengthened and the heating step is performed sequentially to the step of removing the solvent.

The shape retention ratio upon heating of the separator thus obtained is preferably 95% or more, and more preferably 97% or more in a machine direction or a transverse direction at high-temperatures at which shutdown occurs. The machine direction as used herein is a longitudinal direction in forming a sheet and the transverse direction as used herein is a width direction in forming a sheet. High temperatures at which shutdown occurs are temperatures of 80 to 180° C., and usually temperatures of about 130 to 150° C.

The separator according to the present invention has an air permeability (as Gurley value) of preferably 50 to 2000 seconds/100 cc, and more preferably 50 to 1000 seconds/100 cc as with the air permeability of the laminated porous film. Moreover, a smaller change in the air permeability before and after the B-layer modification is preferred.

By such a production method, the separator according to the present invention can be stably supplied, and the separator is excellent in heat shape retainability during heating and is suitable for a separator for a non-aqueous electrolyte secondary battery.

### <Non-Aqueous Electrolyte Secondary Battery>

The non-aqueous electrolyte secondary battery of the present invention is formed by using the separator produced by the method of the present invention.

Hereinafter, a lithium secondary battery will be described as a suitable example of the non-aqueous electrolyte secondary battery of the present invention; however, the present invention is not limited to this example.

A non-aqueous electrolyte secondary battery usually includes an electrode group formed by laminating a negative electrode sheet, a separator and a positive electrode sheet, and a non-aqueous electrolyte; however, the non-aqueous electrolyte secondary battery of the present invention uses the separator of the present invention as a separator.

A non-aqueous electrolyte secondary battery, which uses the separator of the present invention, becomes a non-aqueous electrolyte secondary battery having high load characteristics and high safety since the separator exerts a shutdown function to avoid contact between the positive electrode and the negative electrode due to shrinkage of the separator even when the battery causes abnormal heat generation.

The shape of the non-aqueous electrolyte secondary battery of the present invention is not particularly limited, and may be any of a paper shape, a coin shape, a cylindrical shape, and a prismatic shape and a laminate shape.

As the positive electrode sheet, a sheet in which a mixture containing a positive electrode active material, a conductive material and a binding material is supported on a current collector can be generally used. Specifically, a sheet containing a material capable of being doped or dedoped with lithium ions as the positive electrode active material, a carbonaceous material as the conductive material, and a thermoplastic resin as the binding material can be used. Examples of the material capable of being doped or dedoped with a lithium ion include lithium composite oxides containing at least one of transition metals such as V, Mn, Fe, Co, and Ni. Among these, preferred are lithium composite oxides having an α-NaFeO₂ structure such as lithium nickel oxide and lithium cobalt oxide; and lithium composite oxides having a spinel structure such as lithium manganese spinel in point of high average discharge voltage.

The lithium composite oxide may contain a variety of metal elements, and particularly when a composite lithium nickel oxide, which contains at least one metal element selected from the group consisting of Ti, V, Cr, Mn, Fe, Co, Cu, Ag, Mg, Al, Ga, In and Sn in an amount of 0.1 to 20% by mole with respect to the sum of the number of moles of the metal element and the number of moles of nickel in lithium nickel oxide, is employed, it is preferred since cycle characteristics in the case of use at a high capacity are improved.

Examples of the binding material include thermoplastic resins such as polyvinylidene fluoride, a copolymer of vinylidene fluoride, polytetrafluoroethylene, tetrafluoroethylene-hexafluoropropylene copolymer, tetrafluoroethylene-perfluoroalkylvinylether copolymer, ethylene-tetrafluoroethylene copolymer, vinylidene fluoride-hexafluoropropylene-tetrafluoroethylene copolymer, thermoplastic polyimide, polyethylene, and polypropylene.

Examples of the conductive material include carbonaceous materials such as natural graphite, artificial graphite, cokes, and carbon black. These materials may be used singly, or may be used, for example, as a mixture of artificial graphite and carbon black.

As the negative electrode sheet, a sheet in which a mixture containing a material capable of being doped or dedoped with lithium ions and a binding material, and lithium metal or lithium alloy are supported on a current collector can be generally used. Examples of the material capable of being doped or dedoped with lithium ions include carbonaceous materials such as natural graphite, artificial graphite, cokes, carbon black, thermally decomposed carbons, carbon fibers, and baked materials of organic polymer compounds; oxides doped or dedoped with lithium ions at a potential lower than positive electrode; and chalcogen compounds such as sulfides. With respect to the carbonaceous material, carbonaceous materials predominantly composed of graphite materials such as natural graphite and artificial graphite are preferred in that since potential flatness is high and an average discharge potential is low, a high energy density can be obtained in combination with positive electrode.

As the non-aqueous electrolyte, for example, a non-aqueous electrolyte obtained by dissolving a lithium salt in an organic solvent can be used. Examples of the lithium salt include one kind among LiClO₄, LiPF₆, LiAsF₆, LiSbF₆, LiBF₄, LiCF₃SO₃, LiN(SO₂CF₃)₂, LiC(SO₂CF₃)₃, Li₂B₁₀Cl₁₀, lower aliphatic lithium carbonate and LiAlCl₄, and mixtures of two or more kinds thereof. Among these, lithium salts containing at least one selected from the group consisting of LiPF₆, LiAsF₆, LiSbF₆, LiBF₄, LiCF₃SO₃, LiN(CF₃SO₂)₂, and LiC (CF₃SO₂)₃, respectively containing fluorine, are preferably used as the lithium salt.

As the non-aqueous electrolyte, it is possible to use, for example, carbonates such as propylene carbonate, ethylene carbonate, dimethyl carbonate, diethyl carbonate, ethylmethyl carbonate, 4-trifluoromethyl-1,3-dioxoran-2-one and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran and 2-methyltetrahydrofuran; esters such as methyl formate, methyl acetate and γ-butyrolactone; nitriles such as acetonitrile and butyronitrile; amides such as N,N-dimethylformamide and N,N-dimethylacetoamide; carbamates such as 3-methyl-2-oxazolidone; sulfur-containing compounds such as sulfolane, dimethyl sulfoxide and 1,3-propanesultone; or the above-mentioned organic solvents having a fluorine substituent introduced therein, and a mixture of two or more thereof is usually used.

Among these, a solvent containing carbonates is preferred, and a mixture of a cyclic carbonate and a non-cyclic carbonate, or a mixture of a cyclic carbonate and ethers is more preferred. As the mixture of a cyclic carbonate and a non-cyclic carbonate, mixtures containing ethylene carbonate, dimethyl carbonate and ethylmethyl carbonate are preferred in that the mixtures have a wide operation temperature range and are hardly de composed even when a graphite material such as natural graphite or artificial graphite is used as a negative electrode active material.

### EXAMPLES

Hereinafter, the present invention will be described in more detail by way of examples; however, the present invention is not limited to these examples.

### (1) Thickness Measurement (Unit: μm)

The thickness of a film was measured by a high precision digital length measuring machine manufactured by Mitutoyo Corporation.

(2) Weight Per Unit Area: (Unit: g/m²)

A film was cut out into a piece 10-cm square, and the weight W (g) of the piece was measured. The weight per unit area was calculated by the following equation: weight per unit area (g/m²)=W/(0.1×0.1). The weight per unit area of a heat-resistant layer (B layer) was determined by subtracting the weight per unit area of a substrate material porous film (A layer) from the weight per unit area of a laminated porous film.

### (3) Porosity:

A film was cut out into a piece 10-cm square, and the weight W (g) and thickness D (cm) of the piece were measured. The weight of a material in the sample was calculated, the weight of each material: Wi (g) was divided by a true specific gravity to determine the volume of each material, and the porosity (% by volume) was calculated from the following equation. The weight per unit area of each material was calculated from the amount and ratio of a material used for formation of the film.

Porosity(% by volume)=100−[{(W1/true specific gravity 1)+(W2/true specific gravity 2)+ • •0 • +(1/In/true specific gravity n)}/(100×D)]×100

(4) Air permeability: The air permeability was measured with a digital timer type GURLEY TYPE DENSOMETER manufactured by Toyo Seiki Seisaku-sho, Ltd. in accordance with JIS P 8117.

### (5) Shape Retention Ratio Upon Heating:

A film was cut out into a piece 8-cm square, a marking line of 6-cm square was drawn in the 8-cm square, and the film piece was sandwiched between two sheets of paper and placed in an oven at 150° C. After a lapse of 1 hour, the film piece was taken out from the oven and the dimension of the drawn square was measured to calculate the shape retention ratio upon heating. A calculation method of the shape retention ratio upon heating is as follows.

Length of marking line in machine direction (MD) before heating: L1
Length of marking line in transverse direction (TD) before heating: L2
Length of marking line in machine direction (MD) after heating: L3
Length of marking line in transverse direction (TD) after heating: L4
Shape retention ratio in MD (%)=(L3/L1)×100
Shape retention ratio in TD (%))=(L4/L2)×100

### Example 1

### (1) Preparation of Substrate Material Porous Film (A Layer)

Ultra-high molecular weight polyethylene powder (70% by weight) (340M, produced by Mitsui Chemicals, Inc.) and 30% by weight of polyethylene wax (FNP-0115, produced by NIPPON SEIRO CO., LTD.) having a weight average molecular weight of 1000, and 0.4% by weight of an antioxidant (Irg 1010, produced by Ciba Specialty Chemicals), 0.1% by weight of an antioxidant (P168, produced by Ciba Specialty Chemicals) and 1.3% by weight of sodium stearate with respect to 100 parts by weight of the ultra-high molecular weight polyethylene and the polyethylene wax were added, and to the resulting mixture, calcium carbonate (produced by MARUO CALCIUM CO., LTD.) having an average particle size of 0.1 μm was added so as to be 38% by volume with respect to the whole volume of the mixture. These materials were mixed as powder by a Henschel mixer, and then melt-kneaded by a twin-screw kneader to obtain a polyolefin resin composition. The polyolefin resin composition was rolled with a pair of roller whose surface temperature was 150° C. to prepare a sheet. The sheet was immersed in an aqueous hydrochloride solution (hydrochloric acid 4 mole/L, nonionic surfactant 0.5% by weight) to remove calcium carbonate, subsequently stretched by 6 times at 105° C. to obtain a substrate material porous film made of a polyethylene porous membrane.

Film thickness: 17.1 μm

Weight per unit area: 6.8 g/m²

Air permeability: 86 seconds/100 cc

### (2) Preparation of Coating Liquid

First, to a water-isopropyl alcohol (IPA) mixed solvent (water:IPA=90:10 (by weight)), alumina (α-alumina, AKP-3000 produced by Sumitomo Chemical Co., Ltd.) and polyvinyl alcohol (produced by Wako Pure Chemical Industries, Ltd., Wako first class, average degree of polymerization 3500, degree of saponification 86 to 90%) were added so that the above material had a weight ratio of alumina:PVA=100:3, and the resulting mixture was stirred and mixed.

An antioxidant was added to the mixed solution, and further the mixed solution was passed through Gaulin Homogenizer (15MR-8TA type) manufactured by APV with a pressure of 40 MPa applied to the homogenizer to disperse alumina. The operation of passing the solution with a pressure applied was carried out three times to prepare a coating liquid 1. In addition, the concentration of a solid content was adjusted to 25% by weight.

### (3) Preparation of Laminated Porous Film

The substrate material porous film produced in (1) was subjected to a corona discharge treatment at 50 W/(m²/minute), and then the coating liquid 1 was applied onto one side of the substrate material porous film by using a gravure coating machine and dried at 60° C. to obtain a laminated porous film 1 in which a B layer serving as a heat-resistant layer and the substrate material porous film were laminated. A difference between the maximum value and the minimum value of the film thickness of the B layer was as small as 0.2 μm, and a laminated porous film having good appearance was obtained.

The properties of the laminated porous film 1 are shown together in Table 1.

TABLE 1

| | | | | | | | | | Air |
|---|---|---|---|---|---|---|---|---|---|
| | | | | Weight per unit area | | | | | permeability |
| | Film thickness [μm] | | | [g/m²] | | | Porosity | | (Gurley) |
| | A layer + | | | A layer + | | | [% by volume] | | [second/100 cc] |
| | B | A | B | B | A | B | A | B | A layer + |
| | layer | layer | layer | layer | layer | layer | layer | layer | B layer |
| Laminated | 25.8 | 17.1 | 8.7 | 17.9 | 6.8 | 11.1 | 57 | 66 | 124 |
| porous film 1 | | | | | | | | | |

### (4) Treatment by Compound Having Ability of Cross-Linking PVA

The laminated porous film 1 was cut out into an A4-size, fixed by a metal frame, and immersed in a 3% by weight aqueous solution of boric acid at room temperature for 1 to 2 seconds, and the film fixed by the metal frame was erected vertically to remove the excessive aqueous solution of boric acid by flow-down, and then the film was dried at 70° C. for 3 minutes to obtain a separator of Example 1.

### Example 2

A separator of Example 2 was obtained in the same operational procedure as in Example 1 except for using a 3% by weight aqueous solution of organic titanium compound (titanium lactate, trade name: ORGATIX TC-310, produced by Matsumoto Fine Chemical Co. Ltd.) in place of the 3% by weight aqueous solution of boric acid in (4) Treatment by Compound Having Ability of Cross-linking PVA of Example 1.

### Comparative Example 1

The laminated porous film 1 obtained in Example 1 was evaluated as a separator of Comparative Example 1 as-is.

### Comparative Example 2

A separator of Comparative Example 2 was obtained in the same operational procedure as in Example 1 except for using water in place of the 3% by weight aqueous solution of boric acid in (4) Treatment by Compound Having Ability of Cross-linking PVA of Example 1.

### Comparative Example 3

A boric acid-containing coating liquid prepared by the following operation (2) was used in place of the coating liquid 1 used in Example 1, and a separator of Comparative Example 3 was prepared by the following operation (3).

### (2) Preparation of Boric Acid-containing Coating Liquid

First, to a water-isopropyl alcohol (IPA) mixed solvent (water:IPA=90:10 (by weight)), alumina (AKP-3000 produced by Sumitomo Chemical Co., Ltd.), polyvinyl alcohol (produced by Wako Pure Chemical Industries, Ltd., Wako first class, average degree of polymerization 3500, degree of saponification 86 to 90%), and boric acid were added so that the above material had a weight ratio of alumina:PVA:boric acid=100:3:0.9, and the resulting mixture was stirred and mixed.

Furthermore, the mixed solution was passed through Gaulin Homogenizer (15MR-8TA type) manufactured by APV with a pressure of 40 MPa applied to the homogenizer to disperse alumina. The operation of passing the solution with a pressure applied was carried out three times to prepare a coating liquid 2. In addition, the concentration of a solid content was adjusted to 25% by weight.

### (3) Preparation of Laminated Porous Film

When a substrate material porous film produced in the same manner as in (1) of Example 1 was subjected to a corona discharge treatment at 50 W/(m²/minute) and then the coating liquid 2 was applied onto one side of the substrate material porous film by using a gravure coating machine, the coated surface became rough, a difference between the maximum value and the minimum value of the film thickness of the B layer was as large as 5.9 μm, and uneven coating was found in appearance, and therefore a good laminated porous film could not be attained.

TABLE 2

| | | | Properties of separator | | |
|---|---|---|---|---|---|
| | | | Air permeabil- | Shape reten- | |
| | | | ity (Gurley) | tion ratio | |
| | Laminated | | [second/100 cc] | upon heating | |
| | porous | Cross-linking | A layer + | [%] | |
| | film | solution | B layer | MD | TD |
| Example 1 | Laminated | 3% by weight | 140.3 | 99 | 99 |
| | porous | aqueous solution | | | |
| | film 1 | of boric acid | | | |
| Example 2 | Laminated | 3% by weight | 138.8 | 98 | 97 |
| | porous | aqueous solution | | | |
| | film 1 | of titanium | | | |
| | | lactate | | | |
| Compar- | Laminated | non-treated | 123.6 | 40 | 58 |
| ative | porous | | | | |
| Example 1 | film 1 | | | | |
| Compar- | Laminated | water (without | 116.0 | 43 | 65 |
| ative | porous | cross-linking | | | |
| Example 2 | film 1 | agent) | | | |

### INDUSTRIAL APPLICABILITY

The present invention efficiently and stably provides a laminated porous film having excellent heat shape stability, that is, a laminated porous film which is formed by laminating a heat-resistant layer containing PVA as a binder resin and an inorganic filler on a substrate material porous film. The laminated porous film is suitable for a separator for a non-aqueous electrolyte secondary battery, and therefore the present invention is industrially extremely useful.

1. A method for producing a separator, the method comprising impregnating a laminated porous film, which is formed by laminating a heat-resistant layer containing polyvinyl alcohol (PVA) and an inorganic filler on one side or both sides of a substrate material porous film predominantly composed of polyolefin, with a solution containing a compound having the ability of cross-linking PVA, and then removing a solvent.

2. The method for producing a separator according to claim 1, wherein the compound having the ability of cross-linking PVA is boric acid and/or an organometallic compound having the ability of cross-linking PVA.

3. The method for producing a separator according to claim 2, wherein the organometallic compound having the ability of cross-linking PVA is an organic titanium compound.

4. The method for producing a separator according to claim 3, wherein the organic titanium compound is titanium lactate.

5. The method for producing a separator according to claim 1, wherein the solvent in the solution containing a compound having the ability of cross-linking PVA is a solvent predominantly composed of water.

6. The method for producing a separator according to claim 1, wherein the inorganic filler is alumina.

7. The method for producing a separator according to claim 1, wherein a proportion of polyvinyl alcohol in the heat-resistant layer is 1 part by weight or more and 5 parts by weight or less with respect to 100 parts by weight of the inorganic filler.

8. A non-aqueous electrolyte secondary battery including the separator obtained by the method according to claim 1.
